(19) United States
(12) Patent Application Publication
(10) Pub. No.: US 2014/0309925 A1
(43) Pub. Date: Oct. 16, 2014

(54) VISUAL POSITIONING SYSTEM

(71) Applicants: Pablo Garcia MORATO, Toledo (ES); Frida ISSA, Haifa (IL)

(72) Inventors: Pablo Garcia MORATO, Toledo (ES); Frida ISSA, Haifa (IL)

(21) Appl. No.: 14/140,405

(22) Filed: Dec. 24, 2013

Related U.S. Application Data
(63) Continuation-in-part of application No. 13/969,352, filed on Aug. 16, 2013.

(30) Foreign Application Priority Data
Apr. 14, 2013 (IL) 225756
Apr. 24, 2013 (IL) 225927

(51) Int. Cl. G01C 21/20

(52) U.S. Cl. CPC G01C 21/206
USPC 701/412; 701/418; 701/411

(57) ABSTRACT

A visual positioning system for indoor locations with associated content is provided herein. The system has a map creator and a viewer. The map creator maps the indoor location by acquiring plans thereof, detects paths through the location and associates with the paths frames relating to objects and views of the paths. The viewer allows a user to orient in the indoor location by locating the user with respect to a path. The viewer enhances GPS/WIFI/3G data by matching user-captured images with the frames, and then interactively displaying the user data from the mapped paths with respect to user queries.

### RELATED APPLICATIONS

This application claims priority to Israel Patent Application No. 225756, filed Apr. 14, 2013, and the contents of which is herein incorporated by reference in its entirety. This application is also related to U.S. application Ser. No. 14/140,288, entitled “3D Rendering for Training Computer Vision Recognition,” by Frida Issa and Pablo Garcia Morato, filed the same date as this application, and U.S. application Ser. No. 13/969,352, entitled “3D Space Content Visualization System,” by Pablo Garcia Morato and Frida Issa, filed Aug. 16, 2013, the contents of both of which are incorporated by reference in their entireties.

### FIELD OF THE INVENTION

The present invention relates to the field of indoor orientation, and more particularly, to a visual positioning system.

### BACKGROUND

It is often desired to be able to locate and find things or places in an indoor environment. For example, a user arrives to a mall for the first time, the building is huge, he has several floors and he just wants to buy a specific brand of sport shoes. The first user approach will be to find the mall staff, which in many cases are few and/or are occupied helping other customers. The other way is to try to find the mall's map in order to find at least on which floor is the sports area. Finally the user would reach that sports area and again try to find mall staff to ask or even try to look for a specific shoe of a specific brand. There are many users that are just in a hurry, do not want to walk through all the mall, have little time, and just want to find a specific asset. For such users there is no adequate solution.

This same example can be extrapolated to a user in a book, movies or music store, in a hospital, university, transportation facilities like metro stations, bus stations or airports, cultural places like museums, art centers, music halls, sport places like stadiums, conferences from all kinds, nursing homes for elderly people, or even corporate buildings of big companies. Basically any user at any indoor place or open small place that the GPS accuracy imperfection can be unsatisfying, or has a location issue, first to know exactly where he is standing in the whole facility and second, how and where to go to reach a specific place, asset, or service he is looking for.

Indoor location is as important to common users as outdoor location. While the second has been successfully satisfied by GPS in an accurate and robust way, the first one still does not have proper widespread solutions as typical outdoor navigation systems.

Hardware-based solutions exist already, using WIFI hotspots or proprietary hardware systems that let users locate their devices in indoor places with greater or lesser accuracy. Other solutions are based on WIFI and GPS together, or even device sensors like a magnetometer measuring magnetic field unique values. There are even other solutions that use QR or bi-dimensional codes to locate the device. The device can read those codes and retrieve the location info coded in them.

As almost all current solutions require extra hardware installation or manipulation of the environment in order to target flags for a later recognition, those solutions are expensive, difficult to maintain and spread between common users, and except for the QR code-based ones, none of them has 100% accuracy.

### SUMMARY OF THE INVENTION

One aspect of the present invention provides a visual positioning system comprising (i) a map creator configured to map a given indoor location by acquiring at least one plan of the indoor location; deriving a plurality of paths through the indoor location with respect to the at least one plan; and associating a plurality of corresponding frames with at least some of the derived paths; and (ii) a viewer configured to allow a user to orient in the indoor location using the derived paths by locating the user with respect to at least one respective path using GPS/WIFI/3G data, enhanced by matching at least one image taken by the user with at least one of the frames; and interactively displaying the user data from the mapped paths with respect to user queries.

Another aspect of the present invention provides a visual positioning system comprising (i) a map creator configured to map a given indoor location by acquiring at least one plan of the indoor location; deriving a plurality of paths through the indoor location with respect to the at least one plan; and associating a plurality of corresponding frames with at least some of the derived paths; and (ii) a viewer configured to allow a user to orient in the indoor location using the derived paths by locating the user with respect to at least one respective path using positioning data enhanced by matching at least one image taken by the user with at least one of the frames; and interactively displaying the user data from the mapped paths with respect to user queries.

Another aspect of the present invention provides a visual positioning method comprising (i) mapping a given indoor location by acquiring at least one plan of the indoor location; (ii) deriving a plurality of paths through the indoor location with respect to the at least one plan; (iii) associating a plurality of corresponding frames with at least some of the derived paths; and (iv) providing orientation information to a user relating to the indoor location using the derived paths by locating the user with respect to at least one respective path using positioning data enhanced by matching at least one image taken by the user with at least one of the frames; and interactively displaying the user data from the mapped paths with respect to user queries.

Another aspect of the present invention provides a visual positioning method comprising (i) acquiring at least one plan of an indoor location; (ii) deriving, at least partially based upon the at least one acquired plan, a plurality of paths through the indoor location; (iii) associating with at least some of the derived paths, a plurality of corresponding frames retrieved from at least one of a video feed and a picture feed, wherein the frames are associated to paths in relation to objects depicted in the frames and located along the corresponding paths; (iv) generating, storing and allowing a search within a plurality of maps of the indoor location, each map comprising at least one of the paths with associated frames and related coordinates in a predefined coordinate system associated with the indoor location; (v) locating a user with respect to the plurality of maps of the indoor location by receiving, for a user's communication device, positioning data and at least one image of a user's surroundings, and identifying the user's location by enhancing the positioning data through matching the received at least one image with the at least one of the path-associated frames; and (vi) presenting the user with information from the map that corresponds to the user's location, and in relation to the corresponding derived paths, as well as with possible paths from the user's location to at least one user specified object, using the plurality of maps.

Another aspect of the present invention provides a computer-readable storage medium including instructions stored thereon that, when executed by a computer, cause the computer to (i) map a given indoor location by acquiring at least one plan of the indoor location; (ii) derive a plurality of paths through the indoor location with respect to the at least one plan; (iii) associate a plurality of corresponding frames with at least some of the derived paths; (iv) provide orientation information to a user relating to the indoor location using the derived paths by locating the user with respect to at least one respective path using positioning data enhanced by matching at least one image taken by the user with at least one of the frames; and (v) interactively display the user data from the mapped paths with respect to user queries.

Another aspect of the present invention provides a computer-readable storage medium including instructions stored thereon that, when executed by a computer, cause the computer to (i) acquire at least one plan of an indoor location; (ii) derive, at least partially based upon the at least one acquired plan, a plurality of paths through the indoor location; (iii) associate with at least some of the derived paths, a plurality of corresponding frames retrieved from at least one of a video feed and a picture feed, wherein the frames are associated to paths in relation to objects depicted in the frames and located along the corresponding paths; (iv) generate, store, and allow a search within a plurality of maps of the indoor location, each map comprising at least one of the paths with associated frames and related coordinates in a predefined coordinate system associated with the indoor location; (v) locate a user with respect to the plurality of maps of the indoor location by receiving, for a user's communication device, positioning data and at least one image of a user's surroundings, and identifying the user's location by enhancing the positioning data through matching the received at least one image with the at least one of the path-associated frames; and (vi) present the user with information from the map that corresponds to the user's location and in relation to the corresponding derived paths, as well as with possible paths from the user's location to at least one user-specified object, using the plurality of maps.

These additional, and/or other aspects and/or advantages of the present invention are set forth in the detailed description which follows.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a high-level schematic block diagram of a visual positioning system, according to some embodiments of the invention;

FIGS. 2A and 2B schematically illustrate the mapping processes on an exemplary plan, according to some embodiments of the invention;

FIGS. 3A, 3B, and 3C are high-level schematic flow charts illustrating the flow of operation of a map creator, according to some embodiments of the invention;

FIGS. 4, 5A, 5B, and 5C illustrate the flows that describe stages of operation of the viewer, according to some embodiments of the invention;

FIG. 6 is a high-level flowchart illustrating a visual positioning method, according to some embodiments of the invention; and

FIGS. 7-12 schematically illustrate mapping processes using a map creator on an exemplary plane, according to some embodiments of the invention.

### DETAILED DESCRIPTION

With specific reference now to the drawings in detail, it is stressed that the particulars shown are by way of example and for purposes of illustrative discussion of the preferred embodiments of the present invention only, and are presented to provide a useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

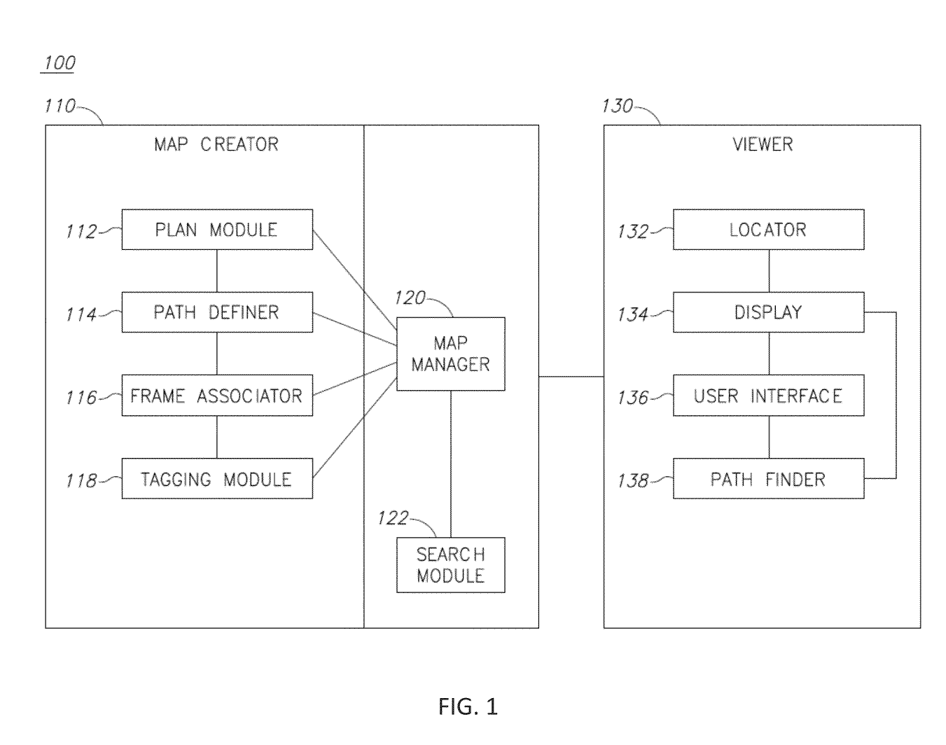

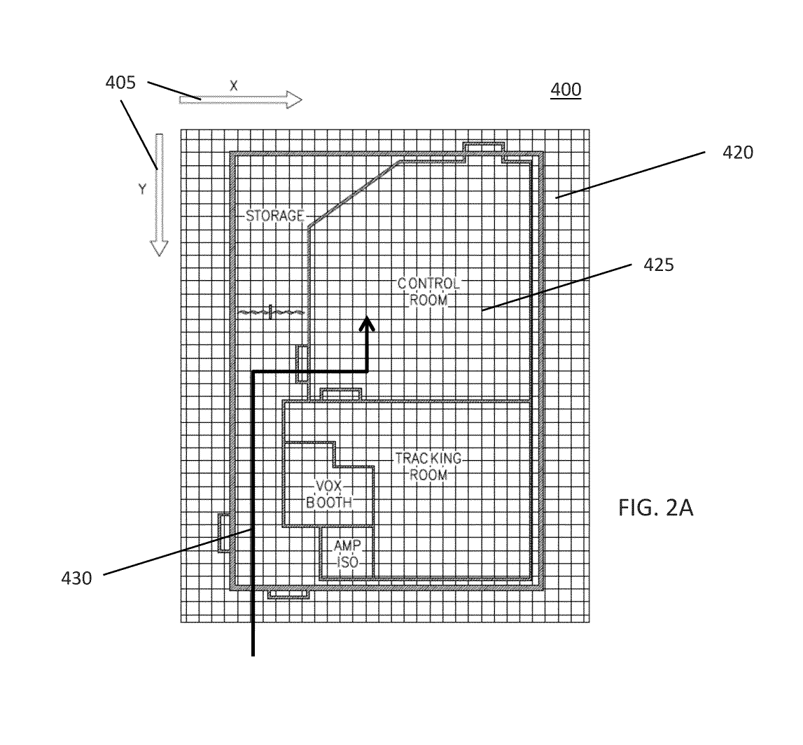

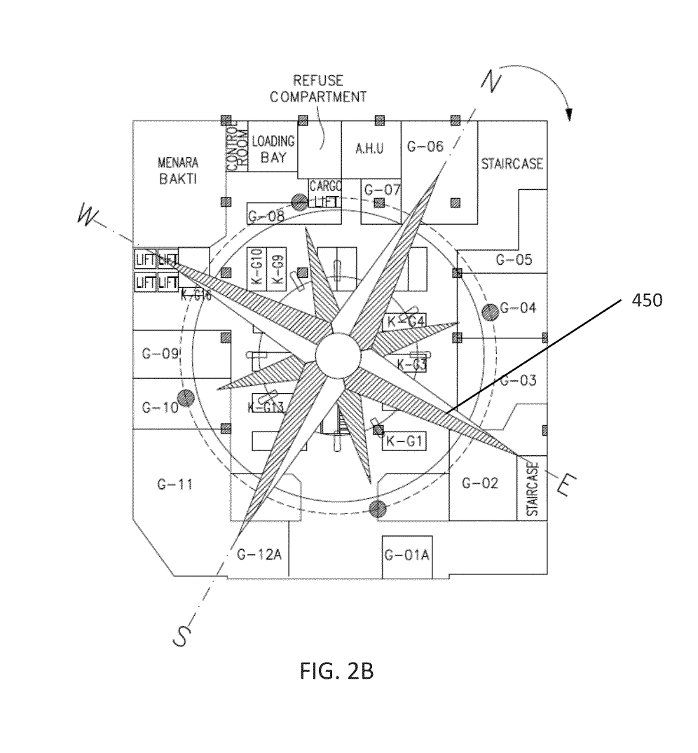

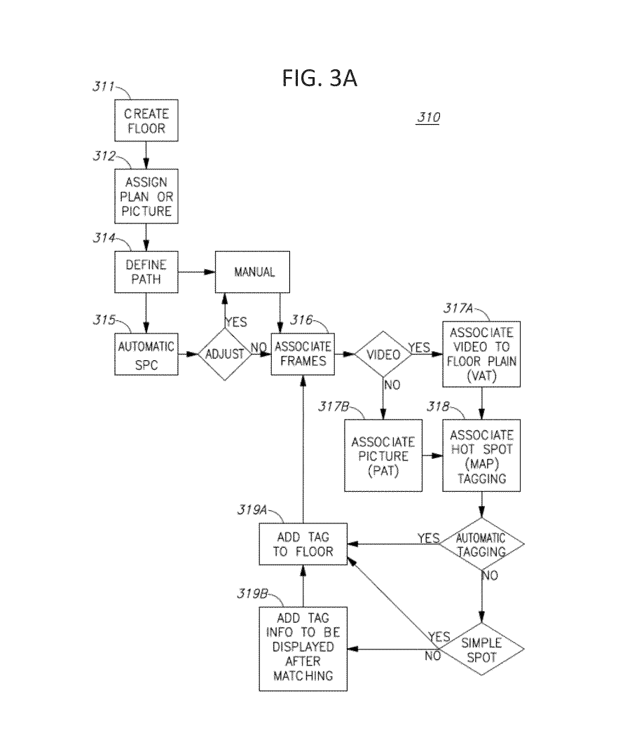

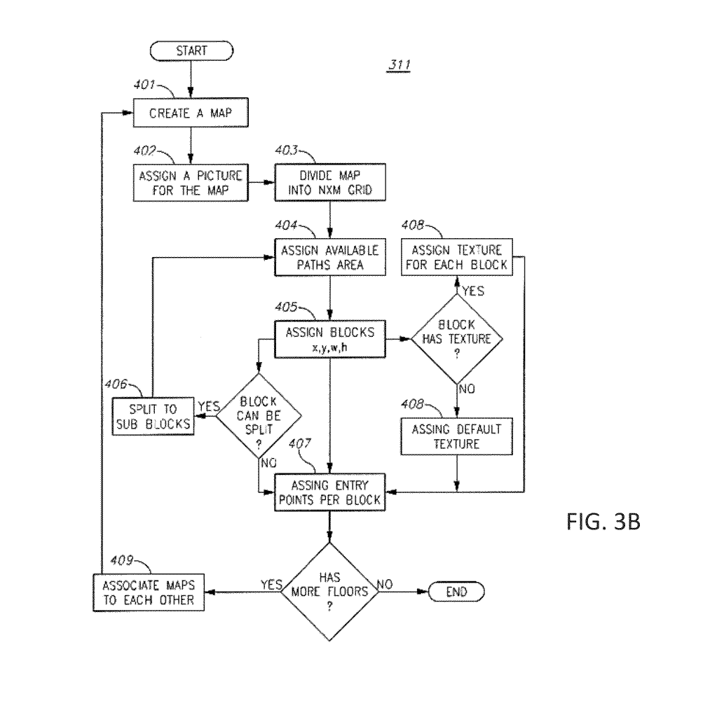

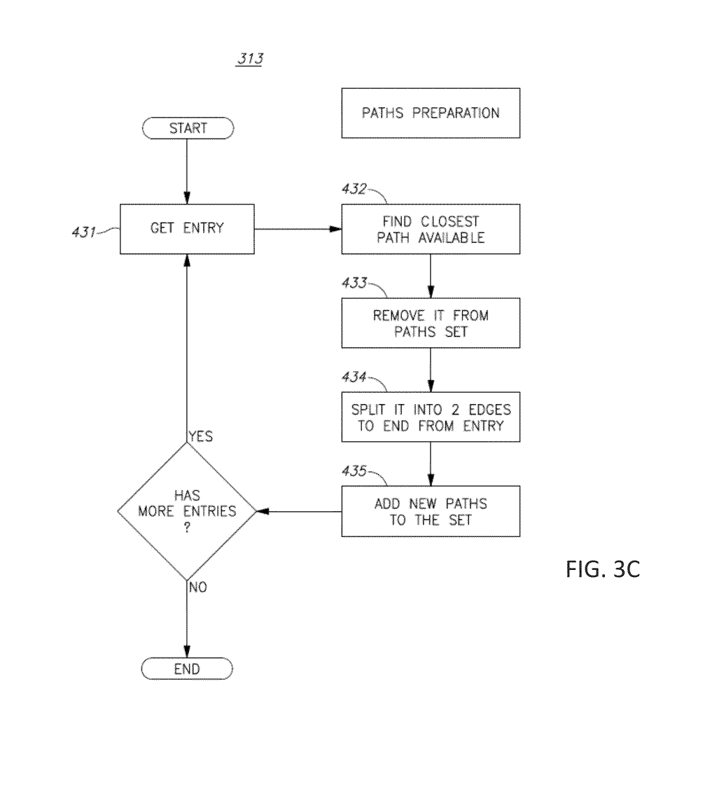

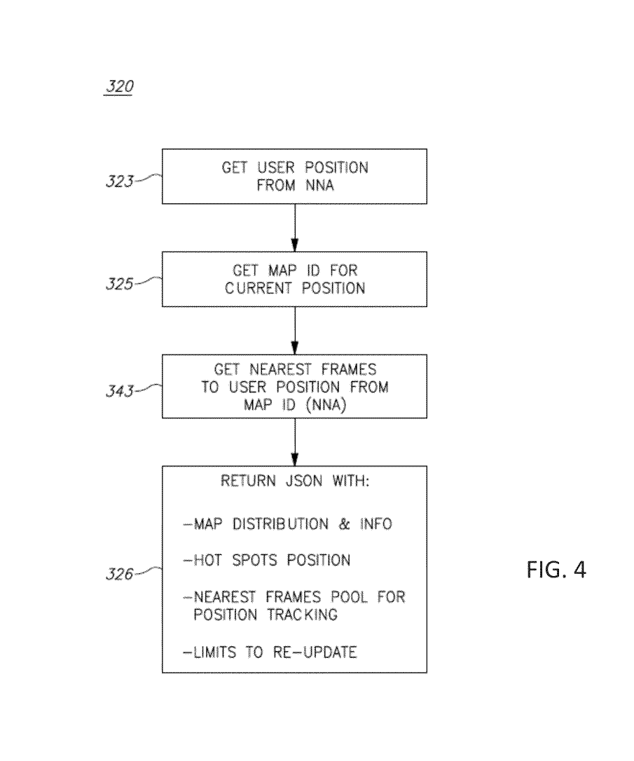

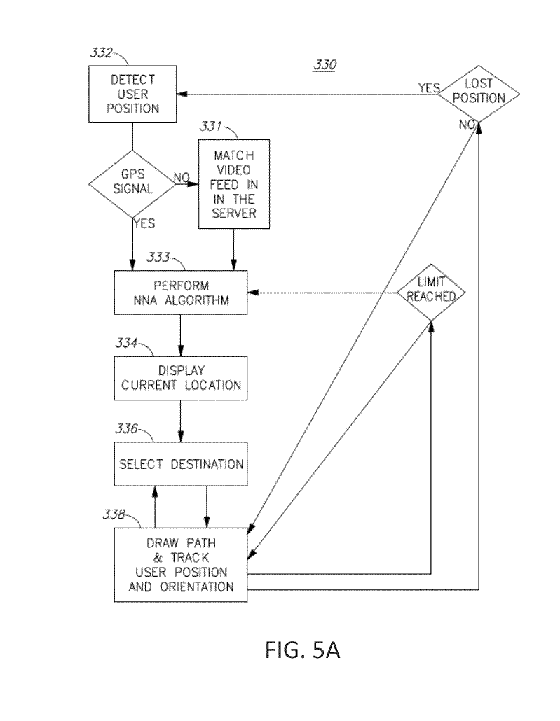

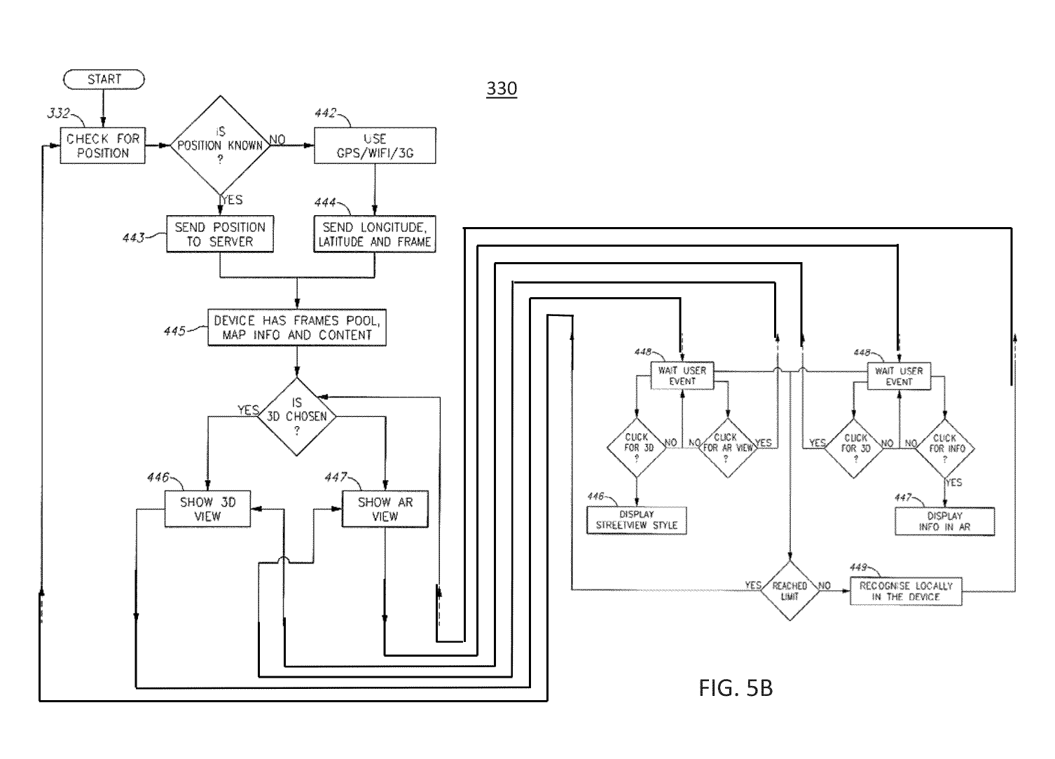

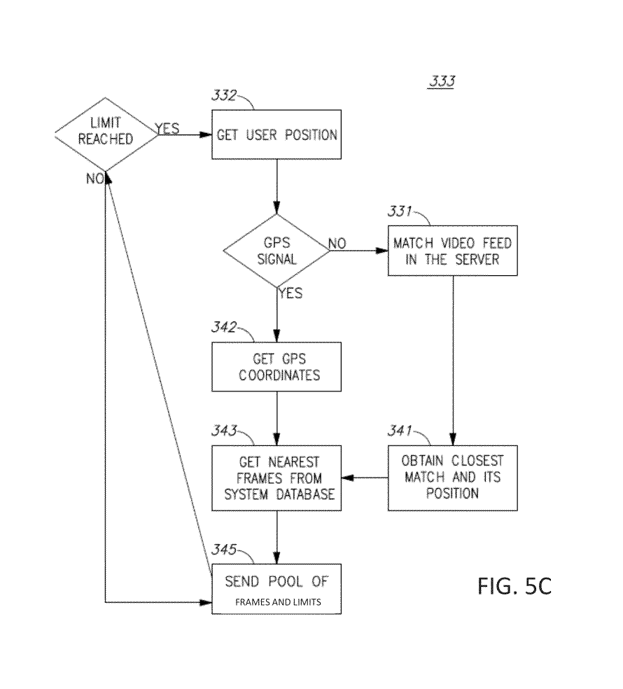

FIG. 1 is a high-level schematic block diagram of a visual positioning system 100, according to some embodiments. FIGS. 2A and 2B schematically illustrate mapping processes on an exemplary plan, according to some embodiments. FIGS. 3-5 are high-level schematic flow charts illustrating the operation of components of visual positioning system 100, according to some embodiments. In particular, FIGS. 3A, 3B, and 3C are high-level schematic flow charts illustrating flow 310 of the operation of map creator 110, according to some embodiments; and FIGS. 4, 5A, 5B, and 5C illustrate flows 320, 330 (FIGS. 5A and 5B), and 333 respectively, that describe stages of operation of viewer 130, according to some embodiments.

Visual positioning system 100 comprises a map creator 110 and a viewer 130. At least part of map creator 110 and/or viewer 130 may be implemented in computer hardware.

Map creator 110 is configured to map a given indoor location (see FIGS. 2A and 2B) by acquiring at least one plan 400 (FIG. 2A) of the indoor location; deriving a plurality of paths 430 through the indoor location with respect to at least one plan 400; and associating a plurality of corresponding frames with at least some of derived paths 430. For example, plan 400 may include several blocks 425 such as rooms and passages through which path 430 is selected. Plan 400 may be processed with respect to a grid 405 in which the size of the subunits 420 define the resolution of the path's calculation and image association (see below). Plan 400 may be prepared for each floor of the given indoor location and may be associated with coordinates 405 with respect to the given indoor location. Each plan 400 may be further provided with an interface that relates plan 400 to the cardinal directions 450 (from FIG. 2B) and allows the user to orient the plan and helps the user to navigate through plan 400.

Map creator 110 may comprise a plan module 112 configured to acquire at least one plan 400 of the indoor location. Plan 400 may be an architectural plan or any image or set of images of the indoor location. Flow 310 illustrates stages of operation of map creator 110. Map creator 110 may create floors (stage 311 from FIG. 3A) and assign plans and paths to each floor (stage 312 from FIG. 3A).

FIG. 3B schematically illustrates stage 311 of creating a floor in map creator 110, according to some embodiments. After map initiation (stage 401), pictures (e.g., plans 400) are added to the map (stage 402), and grid 405 is laid upon the map (stage 403). Available path area is assigned (stage 404) and dimensions are assigned to blocks 425 (stage 405). Blocks 425 are then split if possible (stage 406) and entrances and exits are assigned to each block (stage 407). Finally, textures may be assigned to the blocks (stage 408) and the maps are associated with each other.

Map creator 110 is based on a 3D modeling representation. The 2D representation of the map is the foundational element for building the 3D modeling representation. A 2D representation may be given in several ways. For example, a simple drawing tool following the Scalable Vector Graphics (SVG) format, where images are presented by simple shapes, may be used. Alternatively, a map image may be converted from SVG format. Once in SVG format, the 2D representation may be considered a plane. For example, the plane may measure the width and height of an indoor area in meters. For example, as shown in FIG. 5, the plane 701 may have 50 meters in width and 200 meters in height.

Once in SVG format, the distribution of the blocks over the plane may be defined. A block is a space over the map through which no path passes that may represent a point of interest, a site, or an area of a destination. A block may be split into smaller blocks to define the possible paths between them. In some embodiments, the plane may be divided into columns and rows and considered a grid. For example, a plane may be divided into N columns and M rows to create N×M cells. Each individual block may be a polygon represented by a set of coordinates (x₀, y₀) . . . (xₙ yₘ) where x₀ . . . xₙ belong to the range between [0, N−1] and y₀ . . . yₘ belongs to the range between [0, M−1].

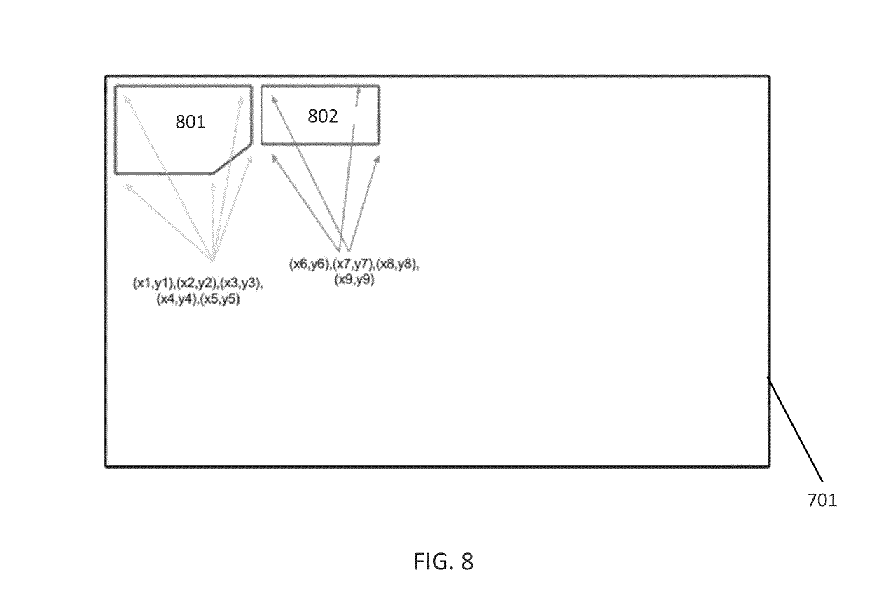

As shown in FIG. 8, the plane 701 may contain blocks 801 and 802. As shown in FIG. 8, block 801 may have vertices represented by (x₁, y₁), (x₂, y₂), (x₃, y₃), (x₄, y₄), and (x₅, y₅). Similarly, block 802 may have vertices represented by (x₆, y₆), (x₇, y₇), (x₈, y₈), and (x₉, y₉).

Map creator 110 may include a path definer 114 arranged to receive at least one acquired plan from plan module 112 and derive, at least partially based thereupon, a plurality of edges through the indoor location. Defining paths (stage 314 from FIG. 3A) may be carried out either manually or automatically (stage 315 from FIG. 3A) by a “smart path creator” (“SPC”) algorithm.

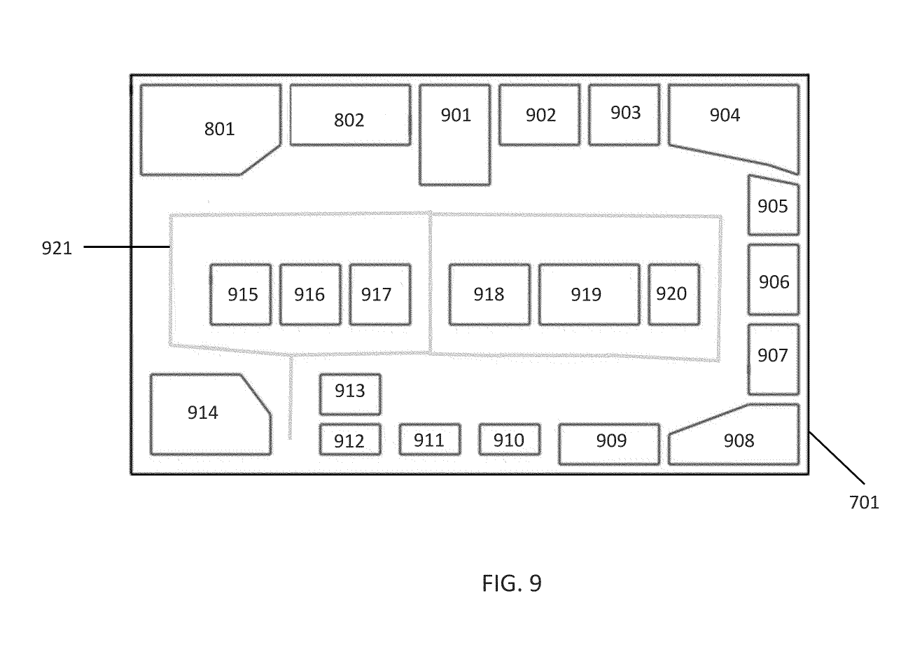

For example, the SPC algorithm may detect black or dark lines within the white or clear space in the plan so the available paths can be marked. Walls, corners and doors, as well as corridors, rooms, and halls may be detected, and available walking paths may be identified. The algorithm may be based on pixel contrast detection, and may distinguish between the dark edges of the lines that represent the map and clear plain spaces that represent the available space. The algorithm may be checked and modified by the user, or the user may input the paths manually. The result of the process may be a basic set of abstract edges. For example, as shown in FIG. 9, an available path 921 may be calculated in plane 701 based on the locations of blocks 801, 802, and 901-920.

After defining paths, either automatically or manually, the next step is defining pathpoints on the map in some embodiments. Pathpoints may be points joining edges from the available path (i.e., joints) or entry points into the blocks. Each pathpoint may have a unique id and a pair of x- and y-coordinates defining its exact position. Entry into the plane or block may be a door, or any access available to a block. In some embodiments, reaching a pathpoint belonging to a block may mean reaching access to the block itself.

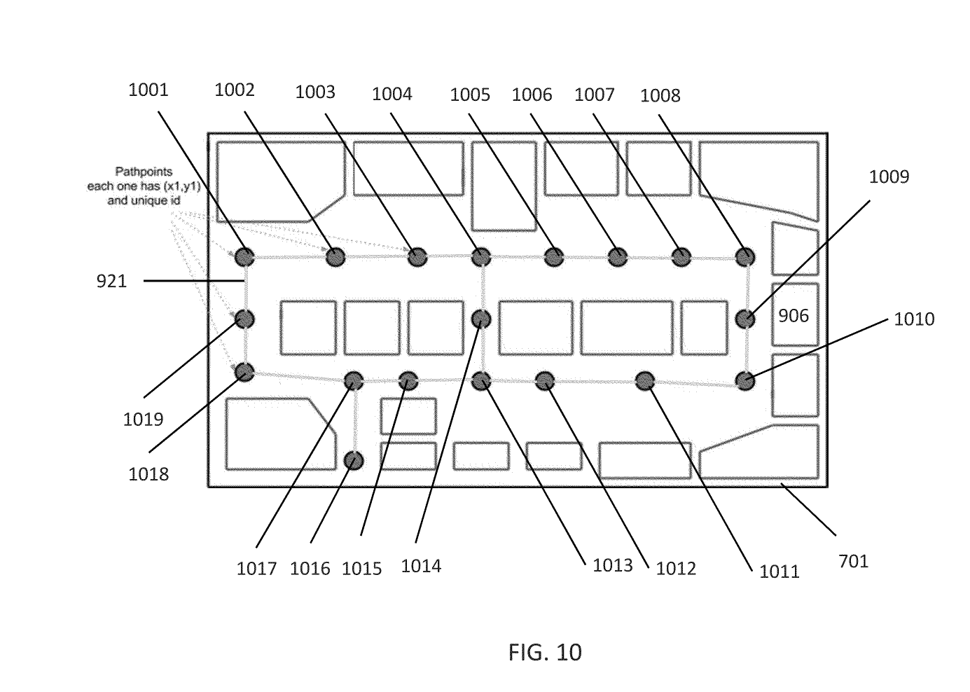

An algorithm may be used to assign pathpoints for use as an entry into each block (“entry points”) and as potential “hot spots.” For example, in FIG. 10, pathpoint 1009 may be an entry point to block 906, which may represent a store or boutique in a shopping mall. In some embodiments, each entry point of a block may take the closest edge from the group prepared in the previous step [(x₁, y₁),(x₂, y₂)], remove it from the set, and split it into two edges: [(x₁, y₁),(x_{entry}, y_{entry})] and [(x_{entry}, y_{entry}),(x₂, y₂)]. The new two edges may be added to the set of the previous step. This may be done for all the blocks in the map and for each entry point of each block. In FIG. 10, pathpoints 1001-1019 may be calculated on the available path.

FIG. 3C schematically illustrates a flow 313 of a path preparation algorithm to define pathpoints, according to some embodiments of the invention. Flow 313 may collect all entry points to blocks 425 and to other relevant elements (stage 431) and may find the closest edge 430 available (stage 432). Then the closest available edge may be removed from the set of paths (stage 433), and may be split into two new edges, one portion from the beginning of the selected path until the entry and another portion from the entry to the end of the selected edge (stage 434). The new edges may then be entered to the set of paths (stage 435). Flow 313 then continues with the next entry.

Each edge may be identified by a unique id and the two ids of the pathpoints that it connects. The edge has a total distance attribute calculated by the distance of the two pathpoints it connects. For example, in FIG. 10, the path from 1001 to 1018 may have a total distance of 16 meters based on a distance of 8 meters from 1001 to 1019 and a distance of 8 meters from 1019 to 1018.

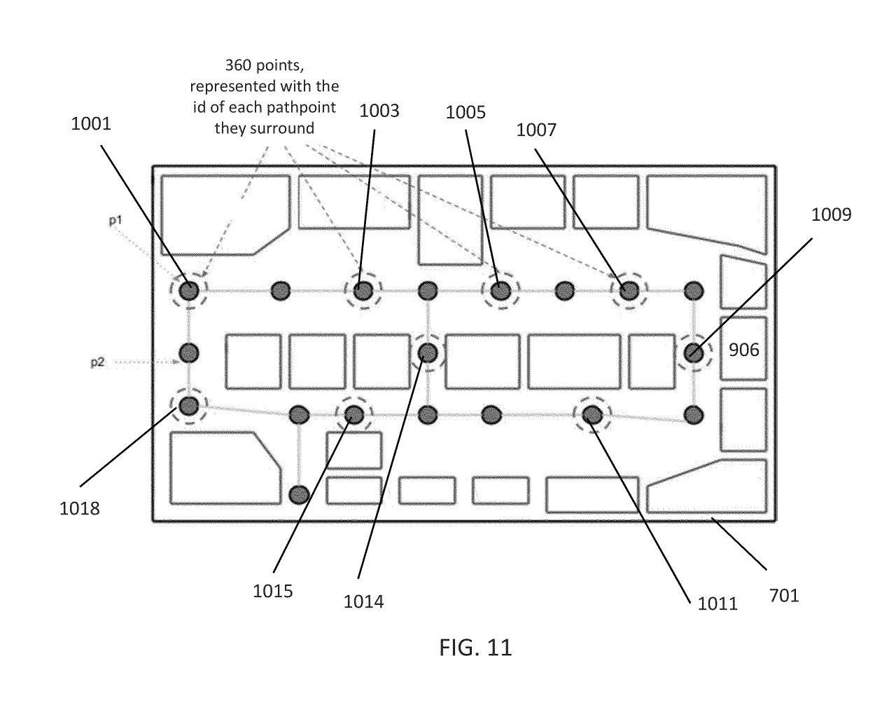

In addition, a map may have “special” pathpoints that provide extra functionality beyond being merely a position holder. For example, a “special” pathpoint may be one that provides a 360-degree feature, where a spherical view of the entire environment from this point may be displayed using a sphere and a texture made of a spherical photo. For example, in plane 701, pathpoints 1001, 1003, 1005, 1007, 1009, 1011, 1014, 1015, and 1018 may be designated as “special” pathpoints as shown in FIG. 11.

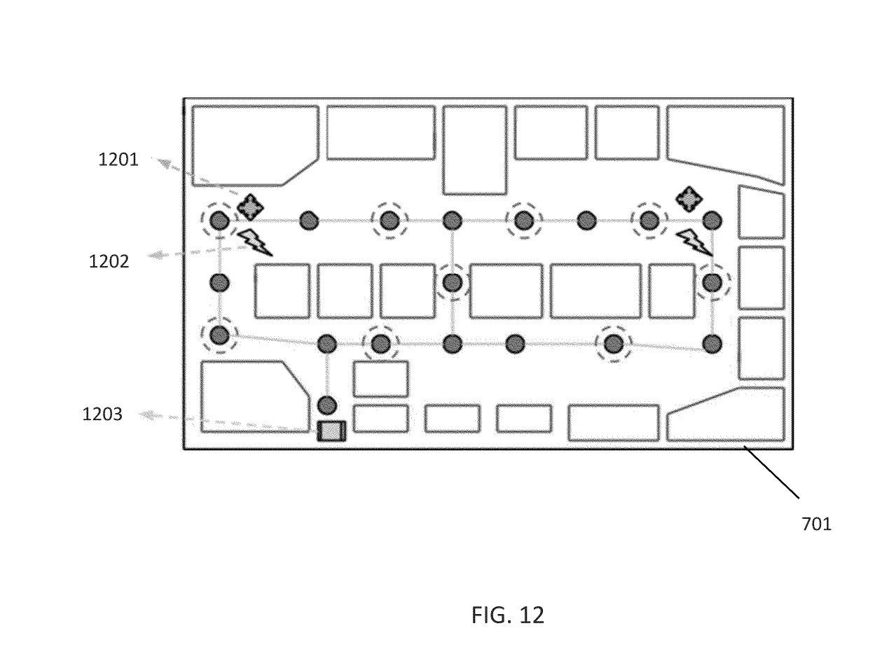

Common mapping objects, such as elevators (e.g., 1201), stairs or escalators (e.g., 1202), and toilets (e.g., 1203), may also be present in the maps. Those objects may be represented by 2D images as shown in FIG. 12.

Map creator 110 at this point may have enough two-dimensional information to convert the whole map into a three-dimensional model. To convert to three dimensions, each polygon in the two-dimensional map may be assigned a height level. This height level may be used to convert the two-dimensional polygons into a three-dimensional object by converting each polygon coordinate from (x, y) format to (x, y, z) format, where the variable “z” reflects the height level. To shape the three-dimensional object, each pair of polygon coordinates (x₁, y₁) and (x₂, y₂) that may represent a two-dimensional vertex may be converted into a four-coordinate set of (x₁, y₁, 0), (x₂, y₂, 0), (x₁, y₁, z₁), (x₂, y₂, z₁) to create an envelope “face” of the three-dimensional model. Similarly, all the polygon coordinates (x₁, y₁) . . . (xₙ, yₙ) are converted into (x₁, y₁, 0) . . . (xₙ, yₙ, 0) coordinates to create the bottom face of the polygon, and (x₁, y₁, z) . . . (x₁, y₁, z) coordinates to create the top face of the polygon. For each block, a texture may be assigned to each face created by the three-dimensional conversion.

The pathpoints may be converted to invisible position holders to define 360-degree scene positions.

In order to generate density and thickness to the three-dimensional edge of a block (which may be representing walls) each may incorporate offsets. For example, a face created from pathpoints coordinates (x₁, y₁) and (x₂, y₂) may result in a plane defined by coordinates (x₁−offset, y₁, 0), (x₁+offset, y₁, 0), (x₂−offset, y₂, 0), (x₂+offset, y₁, 0). Common objects, such as elevators, stairs, and toilets, may be replaced by 3D models that represent them. For example, in the position where a two-dimensional image of an elevator is represented, a three-dimensional model of an elevator may be placed in that position. Common objects may also appear inside the blocks. For example, blocks representing restaurants may contain three-dimensional models of tables, plates, and/or chairs. A block representing a clothing store may contain three-dimensional models representing clothing racks, shelves, and cash registers.

Map creator 110 comprises a frame association tool 116 arranged to associate with at least some of the derived paths, a plurality of corresponding frames retrieved from at least one of a video feed and a picture feed, wherein the frames are associated to paths in relation to objects depicted in the frames and located along the corresponding paths. The frames may relate to various objects along the paths, such as stores, restrooms, exits, etc.

As illustrated in FIG. 3A, frames may be associated (stage 316) by extracting them from either a video feed (317A) or a picture feed (317B).

In the former (stage 317A), the user may record the environment of the indoor location and the video may be associated with the indoor location using a video edition tool (video associated tool—VAT). The tool basically represents a time line along which the video frames are displayed. The user can associate pools of frames defined by start and end frame point to specific areas in the map.

In the latter (stage 317B), frames are directly associated to pictures. The user can take several pictures of the hot areas which he wants to be recognized within the map, and associate those pictures to those areas with a picture associated tool—PAT. The PAT is basically a simplified version of the VAT that lets the user associate images to places in the map.

Map creator 110 may comprise a tagging module 118 configured to allow a user to tag locations or hot spots along the paths. Tagging may be carried out in advance (stage 319A) or during the use of the system (stage 319B, after the matching described below). Tags and hot spots may be associated with corresponding frames (stage 318).

The hot spots or tags are specific items, areas, or even services the user defines. Let's say that in a mall the user defines that on the fourth floor, which has been already mapped, the music section is located (hot spot=music section) and within the music section there is the classics section (hot spot=classics section) and within the classics section there is a Mozart CD release with special price offer (hot spot=Mozart CD).

Tagging process or hot spot definition: the tagging process can be performed manually or automatically. The process of tagging can be also done just by associating information (simple hot spot) or requesting a visual search to deploy the information (complex hot spot). The information may include, in addition to location, a full content association and service offer. For example, following the above example, the classics area hot spot is an info tag, that allows the user to know that in that area of the map it is located in the classic music area, but on the other hand, the Mozart-specific CD will request the user to scan or match the cover in order to display extra information about the CD.

In manual tagging, the user specifies within the map the hot spot using a GUI tool. The user can create a simple hot spot, which may be a marker or a point of interest, or create a complex one. The complex ones as explained would request to define the image to be matched and the info associated to be displayed.

A typical use case of a simple hot spot is to show specific info to the user concerning the location he is at: “special offer in this corridor if you buy this product.” Another typical use case of the simple hot spot can also be customer reviews or comments over restaurants or shops he is near. A typical use case for a complex hot spot is to offer a service: “scan those covers and get extra info about the product, its price, reviews, etc.”

In automatic tagging, system 100 recognizes predefined objects within the video frames or within the images and tags them as “locatable objects”; those objects are typical objects in public places, such as exit signs, elevators, stairs, etc. System 100 may use an improved version of the visual search algorithm (see below) to match images in real time in the device to locate the user in the viewer to be able to match specific objects with the purpose of tagging. This means that in the automatic mode the user is able to search in the pool of images or video frames for certain specified general objects. The frames in which those objects are found are stored in the system for later search in the viewer.

At this point the map is fully configured and can be edited at any time. The last step is to associate the compass point North to the map (FIG. 2B). This step allows displaying the user orientation when the path is drawn in viewer 130. In order to define the point North, system 100 may include a user-friendly interface functioning like a puzzle where the user plugs the map, moves it with his fingers on a big compass, pointing to the North. Identifying the North may be carried out automatically using data such as positioning data, city plans, etc.

Map creator 110 may comprise a map manager 120 arranged to generate, store, and allow retrieving a plurality of maps of the indoor location, each map comprising at least one of the paths with associated frames and related coordinates in a predefined coordinate system associated with the indoor location.

In order to store each floor of each map in map manager 120 database, the floor's surface is distributed as grid 405 (FIG. 2A). The idea is to keep an analogy with the GPS coordinates, latitude, and longitude, but in a Cartesian distribution x and y. This means each single point of the map is defined by x and y coordinates 405. Map manager 120 stores the real map dimensions defined by the user, the system x and y coordinates and a scaling factor.

The information associated to each hot spot is all saved into a content management system (CMS). The content can vary in all kind of textual or media content, starting from simple text, pictures, video streaming, audio streaming or even actions to trigger in the devices when the hot spot is localized. Another possible content is a 360-degree picture, viewing the block from inside it. This may be used to render a 3D environment of the block in the viewer section. This CMS is kept as part of the Map Manager system architecture.

Once the floor grid distribution is made, map manager 120 associates to the paths and to the frames x, y in order to locate them within the map. When the user defines that a frame is at some specific floor point, once the frame is matched, its position is retrieved and it is correct. So the difficulty of the system is not to locate once the matching has been performed, the difficulty is to assure a robust image-matching algorithm without confusing between spots in the space under different illumination conditions. The frame matching enables system 100 to perform the localization procedure. Hot spots are stored with unique coordinates associated, so not only the location has 100% accuracy but also the search of items or assets.

Map creator 110 may comprise a search module 122 arranged to enable searching map manager 120. The visual search system match algorithm is one of the key points of the whole system. The system may use FERNS (Fast Keypoint Recognition Using Random Ferns) or SURF (Speeded Up Robust Features) extraction and detection algorithm for the first recognition.

The problem with any algorithm of recognition is that it does not give a 100% accuracy, because after a loop over the pictures to match in the frame, there may still be several matching results and the system needs to decide at what point exactly the user is standing. Each algorithm parameter that can be manipulated to restrict the possible distances and rotations of the original picture should be considered. If the system restricts those parameters too much, the user will need to have perfect position of the camera, taking perfect and close snapshots, pointing the camera exactly to the targeted picture, which in this case is not even known for the user. The user is not the one that mapped the floors, he does not know which frames have been associated to the different cells and he needs only to look around, without any reference except for some annotation in the screen.

Therefore, after running an initial detection algorithm such as the FERNS detection algorithm or the SURF, getting a set of X matched pictures, the system runs another loop of calculation, deciding which position is the closest. The detection algorithm gives the information—where is the picture located (x₁, y₁), (x₂, y₂), (x₃, y₃), (x₄, y₄), and where those coordinates may include negative values if part of the detected picture is located outside the frame. First check is to determine if those corners create together a possible match. This is done by checking the geometry of the corners and deciding if the polygons they create are a possible orientation of the original images. Another run over the matched pictures sorts them according to the area they cover inside the frame. Another run calculates the orientation of the pictures matched in the frame. The orientation includes translation and rotation matrix of the picture location. This is calculated relatively to the original pictures in the pool of the map. The picture that has the least depth translation, meaning it covers a bigger area of the frame and with the least degree of rotation, is picked to be the matched one and belongs to a specific cell assigned in the previous steps of the mapping.

In order to be able to match within an “unlimited” pool of images (or frames taken by VAT) the system is fully scalable to keep the response time stable, independent of the images or the number of users requesting localization a time. The map manager system is implemented over server architecture that assures high responsiveness. This system includes the databases of the map creator together with the CMS of associated information. The first recognition done in the mall (as an example for a given indoor location) is executed in the server. Later subsets of the mall frames are downloaded to the mobile covering the closets area around the user's first position detected and the recognition continues locally in the mobile.

The architecture includes several powerful machines, growing in number according to the product needs. One of those machines receives all the requests and searches for the specific machine holding the data of the specific map. The maps are identified by id. The first time a user sends a frame, he sends the latest longitude and latitude given by the device as well. According to those values, the system detects in which maps the user may be and sends the request of position recognition to the machines holding the info of the needed maps. Once the system detects the position and in which map, it sends back to the user the map id, the position, associated information of the hot spot from the CMS, and downloads the visual information saved of the surrounding area.

Viewer 130 is configured to allow a user to orient in the indoor location using the derived paths by locating the user with respect to at least one respective path using GPS data enhanced by matching at least one image taken by the user with at least one of the frames; and interactively displaying the user data from the mapped paths with respect to user queries. FIGS. 4, 5A, 5B and 5C illustrate flows 320 from FIG. 4, 330 from FIGS. 5A and 5B, and 333 from FIG. 5C respectively, that describe stages of operation of viewer 130. Viewer 130 may be in communication with search module 122 and map manager 120, and be configured to allow a user to orient in the indoor location.

Viewer 130 may comprise a locator 132 arranged to locate the user with respect to the plurality of maps of the indoor location by receiving, for a user's communication device, a GPS position/WIFI network location/3G connection location and at least one image of a user's surroundings, and identifying the user's location by enhancing the GPS position through matching the received at least one image with the at least one of the path-associated frames. User position may be detected by receiving GPS/WIFI/3G data (stages 332 from FIGS. 5A and 5C, 342 from FIG. 5C) or by extracting the user position from images received for the user's communication device 323, as explained below.

If viewer 130 gets enough GPS/WIFI/3G accuracy (while the user is about to enter the indoor place or small outdoor areas), viewer 130 downloads the nearest maps (first floor) information. In order to be able to process in real time the video feed, the device camera inputs to viewer 130 a nearest neighbor algorithm—NNA is followed (stages 323 from FIG. 4, 333 from FIGS. 5A and 5C).

Locator 132 implements NNA by real-time vision analysis in order to locate the device's position in real time.

In order to locate the user's communication device (e.g., a smartphone), locator 132 compares each frame received from the video input of the device camera with the frames that compose the map. Once the matching is done, the device can locate the user with 100% accuracy. The problem is that current smartphone or tablet processors are limited. Therefore, in order to perform a real-time visual search the amount of images in the analyzed pool is also limited, for example, to between 20 to 100 images according to the device's processor.

As a result of those limitations, locator 132 downloads limited pools of images to the device following the NNA. This algorithm displays an area and if the user zooms in, out, or moves, locator 132 downloads the new map's info to be shown. NNA checks the initial position of the user and downloads the nearest images that the user can match in a nearby radius area.

To get the initial user position as mentioned previously, locator 132 either gets GPS signal or network positioning or 3G connection position estimation (stage 342 from FIG. 5C) to reduce the possible maps to search against, or gets an initial match in the server against a bigger storage of possible maps (stage 325 from FIG. 4). This second option basically consists of sending the video feed input from the device to the server engine (stage 331 from FIGS. 5A and 5C) in order to match against all the frames (stage 341 from FIG. 5C). The response time is not real time (approximately two seconds depending on the device connection), but the frames are sent automatically (stage 343 from FIG. 5C) until one is matched and the current location of the device plus the nearest frames and the limits are downloaded to the device (stages 345 from FIG. 5C, 326 from FIG. 4). The limits are the coordinates of the floor map that define the info that was downloaded. This means that once the user moves out of the threshold of the area, he already has info in the device about prospective paths. The device updates the info automatically with no need to perform again the server match or the GPS/WIFI/3G positioning retrieval.

Viewer 130 may comprise a display 134 configured to present the user with information from the map that corresponds to the user's location (stage 334 from FIG. 5A) and in relation to the corresponding derived paths (stage 326 from FIG. 4). Once the device is located and is able to display all map information, the user may want to find something: object, place, etc.

Viewer 130 may comprise a user interface 136 configured to answer user queries regarding the derived paths and the objects there along. In case the paths include tags, user interface 136 may be further configured to answer user queries regarding the tags.

If the user wants to look for an object, he can either type its name so that user interface 136 checks if the current map has that tag stored, or take a snapshot of the object so user interface 136 looks for it within the map available frames. If the user wants to look for a place he can touch it on the map and define it as a target (stage 336 from FIG. 5A). In any case, once the destination is defined, user interface 136 calculates the available paths and draws the shortest one (stage 338 from FIG. 5A).

In embodiments, flow 330 comprises the following stages. Checking for the user's position (stage 332 from FIGS. 5A, 5B, 5C), the position is sent to the server (stage 443 from FIG. 5B) or data based on GPS, WiFi, 3G etc. is used (stage 442 from FIG. 5B) and sent as absolute coordinates to the server (stage 444 from FIG. 5B). The user's device then receives from the server map information, including relevant frames and content (stage 445 from FIG. 5B), and presents the data either in a three-dimensional view (stage 446 from FIG. 5B) or in an augmented reality (AR) view (stage 447 from FIG. 5B). Upon detecting user events (stage 448 from FIG. 5B), views may be switched. Upon reaching limits of the downloaded area, user position may be checked again (stage 332 from FIGS. 5A, 5B, 5C) and the flow 330 reiterated.

Once the device is located and is able to display all map information, the user may want to find something: object, place, etc. A 3D model of the map allows the user to explore the floor in 3D, zoom in and out, and tour around. The 3D creation is using the texture defined for each plan over a 3D plane in a dynamic manner. The 3D creation further creates dynamically the blocks with textures over the plan according to the data saved for the plan in the map creator. Another view available is an augmented reality view, allowing the user to see what hot spots are around him and which information and content they associate. If the user wants to look for an object, he can either type its name so the system will check if the current map has that tag stored in the CMS or take a snapshot of the object so the system looks for it within the map available frames. While zooming in into the 3D map, the environment changes and the users will see in the 3D frames of the specific area he is watching. He can click any block on the map and if there is available an inner view of the block, it appears to the user as a 3D sphere with the pictures of the block rendered as a texture of this sphere creating a 360-degree view. For this purpose in the CMS the hotspot of this block must include 360-degree frame content. The same method of grid division is used also in the mobile and the communication between the device and the server uses the same coordinates set in the map manager system.

Viewer 130 may comprise a path finder 138 configured to present the user with possible paths from the user's location to at least one user specified object, using map manager 120.

Path finder 138 operates a path finder algorithm task that finds the fastest walkable path between two places: user position and target. The algorithm expands on the graph from the origin point to the target point by choosing the best node according to some preset rules. The algorithm is implemented in a modular way in path finder 138 so that it can be easily replaced with another algorithm at any time. The algorithm may skip pixels and resize the binary image to make it run faster on mobile devices.

Path finder 138 then draws the path to follow and tracks the user position and orientation. The user orientation is defined using the smartphone or tablet sensors (a device with compass is required) and takes the North reference defined in previous steps when creating the map. The user position tracking is defined by the real-time visual search engine that basically matches within the device against the pools updated by the NNA. At any point the user can switch between viewer 130 and the map creator 110, because the idea is that any user can edit the maps, update blocks, hotspots, paths and entries or any information associated to the hotspots in the CMS.

FIG. 4 is a high-level flowchart illustrating a visual positioning method 200, according to some embodiments of the invention.

Visual positioning method 200 comprises mapping a given indoor location (stage 210) by acquiring at least one plan of the indoor location (stage 212); deriving a plurality of paths through the indoor location with respect to the at least one plan (stage 214); and associating a plurality of corresponding frames with at least some of the derived paths (stage 218).

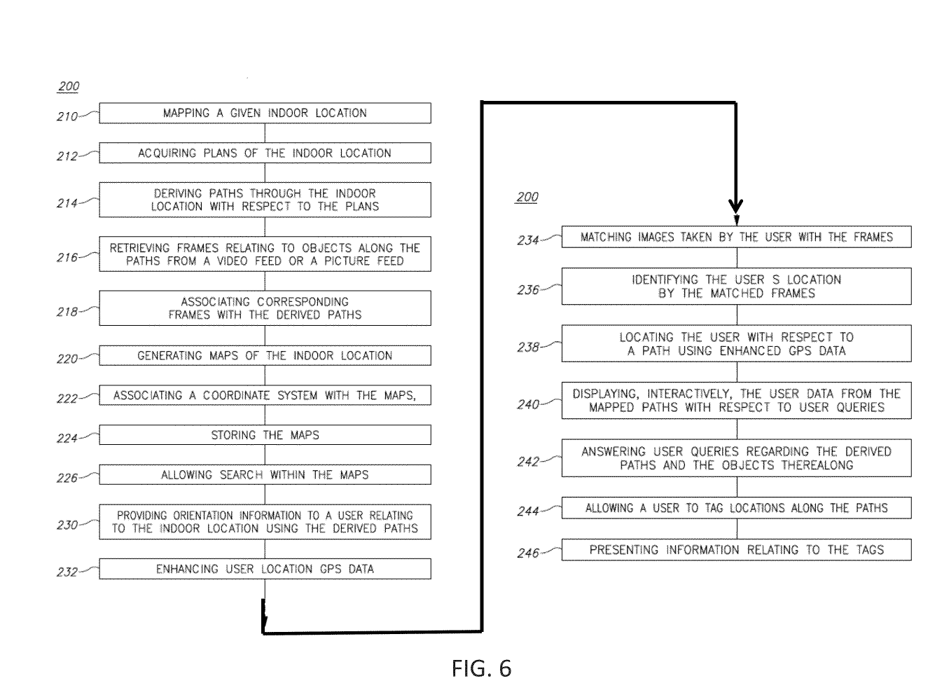

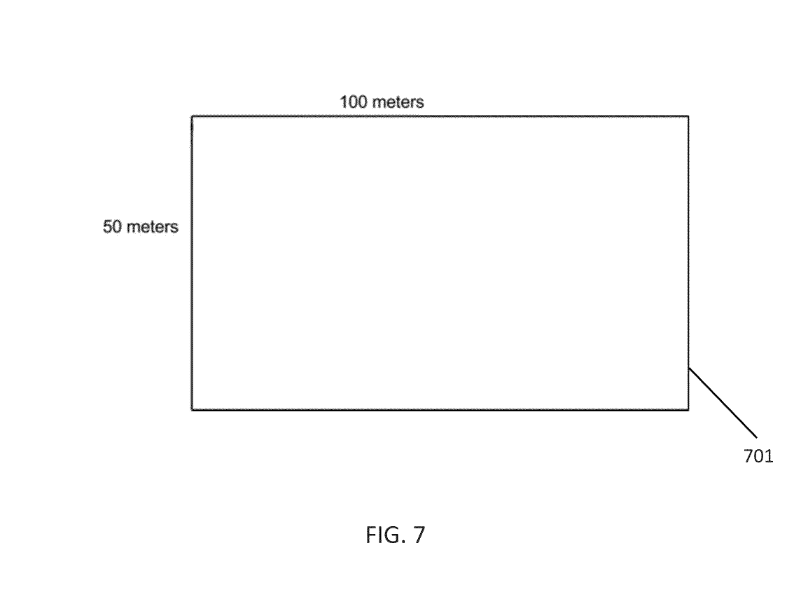

In some embodiments, as shown in FIG. 6, visual positioning method 200 comprises acquiring at least one plan of an indoor location (stage 212); deriving, at least partially based upon the at least one acquired plan, a plurality of paths through the indoor location (stage 214); and associating with at least some of the derived paths (stage 218), a plurality of corresponding frames retrieved from at least one of a video feed and a picture feed (stage 216), wherein the frames are associated to paths in relation to objects depicted in the frames and located along the corresponding paths.

Visual positioning method 200 comprises providing orientation information to a user relating to the indoor location (stage 230) using the derived paths by locating the user with respect to at least one respective path (stage 238) using GPS/WIFI/3G data enhanced (stage 232) by matching at least one image taken by the user with at least one of the frames (stage 234); and interactively displaying the user data from the mapped paths with respect to user queries (stage 240). At least part of mapping 210 and providing 230 is carried out by at least one computer processor.

In embodiments, visual positioning method 200 further comprises generating, storing and allowing a search (stage 220, 224, 226) within a plurality of maps of the indoor location, each map comprising at least one of the paths with associated frames and related coordinates in a predefined coordinate system associated with the indoor location (stage 222).

Visual positioning method 200 further comprises locating a user (stage 238) with respect to the plurality of maps of the indoor location by receiving, for a user's communication device, a GPS/WIFI/3G position and at least one image of a user's surroundings, and identifying the user's location (stage 236) by enhancing the GPS/WIFI/3G position (stage 232) through matching the received at least one image with the at least one of the path associated frames (stage 234).

Visual positioning method 200 further comprises presenting the user with information from the map (stage 230) that corresponds to the user's location and in relation to the corresponding derived paths, as well as with possible paths from the user's location to at least one user specified object, using the plurality of maps.

In embodiments, visual positioning method 200 further comprises answering user queries regarding the derived paths and the objects there along (stage 242).

In embodiments, visual positioning method 200 further comprises allowing a user to tag locations along the paths (stage 244) and presenting information relating to the tags (stage 246).

In embodiments, stages of visual positioning method 200 may be implemented as a computer readable program embodied on a non-transitory computer readable storage medium, such as a magnetic disk, flash memory, read only memory, and/or a field-programmable gate array.

Advantageously, system 100 and method 200 represent a whole system of indoor location including those main features: (i) The system's first part includes a mapping part, a tool to draw a map, drawing the path and assigning the hot spots and tag them; (ii) the system has a database of pictures or whole video tagged with places, each picture or set of pictures/frames from video define one place; (iii) the system has a recognition engine both in the mobiles and in the server; (iv) the server is responsible to recognize where the user is at the beginning; later the part of the database that is close in some radius around the position of the user, and this way the next recognition is in real time in the mobile; while the user is moving and the system recognizes new spots he is at we download new part of the database and so on; (v) the system can also recognize general objects in the picture/video database such as stairs/elevators, etc.; and (vi) the system draws and tracks positions on the map and may provide directions to any other place in the map.

Advantageously, the present system provides a tool to locate assets or specific areas within an indoor environment with 100% accuracy. The solution is based on a natural visual search following human methods of locating. The human eye can recognize places which it previously has seen. Those images matched in the human brain let the people know where they are and how to reach what they desire. Basically the human eye processes a video feed decomposed in frames. Those frames are stored in our memory and we can access some of them by remembering some of them, although all are already located in our brain storage. This system adopts human behavior. Humans need to be fed initially with the indoor environment information through a video or several images. After the environment information is set, through a new pass in the same environment the frames seen are sent to the system. When the system recognizes any frame on memory, it can tell exactly where we are located. Unlike humans, machines are able to process much faster big amounts of information and are not likely to forget any. While for humans it is really difficult to access and process all the frames stored in the brain and analyze them without forgetting any, for a machine it is not a problem at all, it only requires more computational power. Therefore, the present invention emulates basically the human behavior, using computer vision to process and analyze video frames for proximate matching and recognition request.

In the above description, an embodiment is an example or implementation of the invention. The various appearances of “one embodiment,” “an embodiment,” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Embodiments of the invention may include features from different embodiments disclosed above, and embodiments may incorporate elements from other embodiments disclosed above. The disclosure of elements of the invention in the context of a specific embodiment is not to be taken as limiting their used in the specific embodiment alone.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A visual positioning system comprising:
a map creator configured to map a given indoor location and comprising:
a plan module configured to acquire at least one plan of the indoor location;
a path definer arranged to receive the at least one acquired plan from the plan module and derive, at least partially based thereupon, a plurality of paths through the indoor location;
a frame association tool arranged to associate with at least some of the derived paths, a plurality of corresponding frames retrieved from at least one of a video feed and a picture feed, wherein the frames are associated to paths in relation to objects depicted in the frames and located along the corresponding paths;
a map manager arranged to generate, store and allow retrieving a plurality of maps of the indoor location, each map comprising at least one of the paths with associated frames and related coordinates in a predefined coordinate system associated with the indoor location; and
a search module arranged to enable searching the map manager, and
a viewer in communication with the search module and the map manager, the viewer configured to allow a user orient in the indoor location, the viewer comprising:
a locator arranged to locate the user with respect to the plurality of maps of the indoor location by receiving, for a user's communication device, positioning data and at least one image of a user's surroundings, and identifying the user's location by enhancing the positioning data through matching the received at least one image with the at least one of the path associated frames;
a display configured to present the user with information from the map that corresponds to the user's location and in relation to the corresponding derived paths;
a user interface configured to answer user queries regarding the derived paths and the objects there along; and
a path finder configured to present the user with possible paths from the user's location to at least one user specified object, using the map manager.

2. The visual positioning system of claim 1, wherein the map creator further comprises a tagging module configured to allow a user tag locations along the paths, and the user interface is further configured to answer user queries regarding the tags.

3. The visual positioning system of claim 1, wherein the positioning data comprises at least one of GPS positioning data and location data from a communication network of the user's communication device.

4. A visual positioning system comprising:
a map creator configured to map a given indoor location by acquiring at least one plan of the indoor location, deriving a plurality of paths through the indoor location with respect to the at least one plan, and associating a plurality of corresponding frames with at least some of the derived paths; and
a viewer configured to allow a user to orient in the indoor location using the derived paths by locating the user with respect to at least one respective path using positioning data enhanced by matching at least one image taken by the user with at least one of the frames, and interactively displaying the user data from the mapped paths with respect to user queries.

5. The visual positioning system of claim 4, wherein the map creator further comprises a tagging module configured to allow a user to tag locations along the paths, and the viewer is further configured to answer user queries regarding the tags.

6. The visual positioning system of claim 4, wherein the positioning data comprises at least one of GPS positioning data and location data from a communication network of the user's communication device.

7. A visual positioning method comprising:
mapping, with a map creator, a given indoor location by:
acquiring at least one plan of the indoor location,
deriving a plurality of paths through the indoor location with respect to the at least one plan, and
associating a plurality of corresponding frames with at least some of the derived paths; and
providing, with a viewer, orientation information to a user relating to the indoor location using the derived paths by locating the user with respect to at least one respective path using positioning data enhanced by matching at least one image taken by the user with at least one of the frames, and interactively displaying the user data from the mapped paths with respect to user queries.

8. The visual positioning method of claim 7, further comprising allowing a user to tag locations along the paths, and wherein the orientation information further relates the tags.

9. The visual positioning method of claim 7, wherein the positioning data comprises at least one of GPS positioning data and location data from a communication network of the user's communication device.

10. A visual positioning method comprising:
acquiring with a plan module at least one plan of an indoor location;
deriving, with a path deriver module, at least partially based upon the at least one acquired plan, a plurality of paths through the indoor location;
associating with at least some of the derived paths, with a frame association tool, a plurality of corresponding frames retrieved from at least one of a video feed and a picture feed, wherein the frames are associated to paths in relation to objects depicted in the frames and located along the corresponding paths;
generating, storing and allowing search within a plurality of maps of the indoor location with a map manager, each map comprising at least one of the paths with associated frames and related coordinates in a predefined coordinate system associated with the indoor location;
locating, with a locator module, a user with respect to the plurality of maps of the indoor location by receiving, for a user's communication device, positioning data and at least one image of a user's surroundings, and identifying the user's location by enhancing the positioning data through matching the received at least one image with the at least one of the path associated frames; and
on a display, presenting the user with information from the map that corresponds to the user's location and in relation to the corresponding derived paths, as well as with possible paths from the user's location to at least one user specified object, using the plurality of maps.

11. The visual positioning method of claim 10, further comprising allowing a user to tag locations along the paths, and wherein the presenting is carried out in further respect of the tags.

12. The visual positioning method of claim 10, further comprising answering user queries regarding the derived paths and the objects there along.

13. The visual positioning method of claim 10, wherein the positioning data comprises at least one of GPS positioning data and location data from a communication network of the user's communication device.

14. A non-transitory computer-readable storage medium including instructions stored thereon that, when executed by a computer, cause the computer to:
map a given indoor location by acquiring at least one plan of the indoor location;
derive a plurality of paths through the indoor location with respect to the at least one plan;
associate a plurality of corresponding frames with at least some of the derived paths;
provide orientation information to a user relating to the indoor location using the derived paths by locating the user with respect to at least one respective path using positioning data enhanced by matching at least one image taken by the user with at least one of the frames; and
interactively display the user data from the mapped paths with respect to user queries.

15. The computer-readable storage medium of claim 14, wherein the instructions are further configured to cause the computer to allow a user to tag locations along the paths, and wherein the orientation information further relates the tags.

16. The computer-readable storage medium of claim 14, wherein the positioning data comprises at least one of GPS positioning data and location data from a communication network of the user's communication device.

17. A non-transitory computer-readable storage medium including instructions stored thereon that, when executed by a computer, cause the computer to:
acquire at least one plan of an indoor location;
derive, at least partially based upon the at least one acquired plan, a plurality of paths through the indoor location;
associate with at least some of the derived paths, a plurality of corresponding frames retrieved from at least one of a video feed and a picture feed, wherein the frames are associated to paths in relation to objects depicted in the frames and located along the corresponding paths;
generate, store and allow a search within a plurality of maps of the indoor location, each map comprising at least one of the paths with associated frames and related coordinates in a predefined coordinate system associated with the indoor location;
locate a user with respect to the plurality of maps of the indoor location by receiving, for a user's communication device, positioning data and at least one image of a user's surroundings, and identifying the user's location by enhancing the positioning data through matching the received at least one image with the at least one of the path associated frames; and
present the user with information from the map that corresponds to the user's location and in relation to the corresponding derived paths, as well as with possible paths from the user's location to at least one user specified object, using the plurality of maps.

18. The computer-readable storage medium of claim 17, wherein the instructions are further configured to cause the computer to allow a user to tag locations along the paths, and wherein the presented information further relates to the tags.

19. The computer-readable storage medium of claim 17, wherein the positioning data comprises at least one of GPS positioning data and location data from a communication network of the user's communication device.

20. The computer-readable storage medium of claim 17, wherein the instructions are further configured to cause the computer to answer user queries regarding the derived paths and the objects there along.
